(19) United States
(12) Patent Application Publication
(10) Pub. No.: US 2021/0066823 A1
(43) Pub. Date: Mar. 4, 2021

(54) PARALLEL-TYPE WIRE CONNECTOR

(71) Applicant: Xiamen Ghgm Electric Co., Ltd., Xiamen (CN)

(72) Inventor: Bingshui Chen, Xiamen (CN)

(21) Appl. No.: 16/812,836

(22) Filed: Mar. 9, 2020

(30) Foreign Application Priority Data
Aug. 30, 2019 (CN) 201921438229.8

(51) Int. Cl. H01R 4/48; H01R 13/42; H01R 13/502; H01R 13/516

(52) U.S. Cl. CPC H01R 4/4818; H01R 13/516; H01R 13/502; H01R 13/42

(57) ABSTRACT

A parallel-type wire connector comprises a housing formed with a mounting cavity, a conductive clip formed in a ‘V’ like shape and accommodated in the mounting cavity, a support member disposed in the mounting cavity and clamped by the conductive clip, and a plug member provided with wire insertion holes and engaged in the mounting cavity. The conductive clip is arranged with wire passages extending through the conductive clip and elastic sheets disposed at the wire passages. The mounting cavity is arranged with an engagement portion fitting with the plug member, and an air passage. The air passage is located behind and aligned with the engagement portion. The air passage extends through the housing along a direction along which the plug member is inserted into the mounting cavity. The wires can be inserted through wire insertion holes, into the wire passages, and sandwiched between respective elastic sheets and the support member.

### CROSS-REFERENCE TO PRIOR APPLICATION

This application claims the benefit of Chinese Patent Application No. 201921438229.8 filed on Aug. 30, 2019, the contents of which are incorporated herein by reference.

### FIELD OF THE INVENTION

This disclosure relates to the technical field of connectors, more particularly to a parallel-type wire connector.

### BACKGROUND OF THE INVENTION

The parallel-type wire connector is a connector allowing a plurality of wires to simultaneously insert therein to achieve a parallel connection of the plurality of wires.

Existing parallel-type wire connectors usually comprise a housing, a clip assembly mounted in the housing, and a plug member for preventing the clip assembly from being detached from the housing. The existing housing is engaged with the plug member, and it is necessary to provide an engagement portion or an engagement groove inside the housing, which results in a low yield of the housing in the molding and manufacturing process. Further, existing parallel-type wire connectors, which usually are inserted with a plurality of wires, will generate a lot of heat during prolonged use and have a high temperature. To this end, the inventor studied the prior art and now presents this application.

### SUMMARY OF THE INVENTION

The present disclosure provides a parallel-type wire connector which can improve the yield and heat radiation performance.

To this end, the present disclosure provides a parallel-type wire connector. The parallel-type wire connector comprises: a housing formed with a mounting cavity; a conductive clip accommodated in the mounting cavity; a support member disposed in the mounting cavity and clamped by the conductive clip; and a plug member provided with wire insertion holes and engaged in the mounting cavity. The conductive clip is arranged with wire passages extending through the conductive clip and elastic sheets disposed at the wire passages. The mounting cavity is arranged with an engagement portion fitting with the plug member, and an air passage located behind and aligned with the engagement portion. The air passage extends through the housing along a direction along which the plug member is inserted into the mounting cavity, and wires can be inserted through the wire insertion holes, inserted into the wire passages, and sandwiched between respective elastic sheets and the support member.

In some embodiments, the conductive clip may comprise first conductive sheets disposed obliquely upward, and second conductive sheets respectively connected with the first conductive sheets and disposed obliquely downward, wherein the first conductive sheets and the second conductive sheets are disposed to form a first opening therebetween, and the support member can be clamped in the first opening.

In some embodiments, the support member may be a conductive geometry in a ‘V’ like shape, a second opening may be formed at an opening portion of the ‘V’ like shape of the support member, and support pieces may be arranged at joints of the first conductive sheets and the second conductive sheets, the support pieces extending outward and disposed in the second opening.

In some embodiments, the first conductive sheets and the second conductive sheets in the embodiment are respectively arranged with a plurality of wire passages and a plurality of elastic sheets aligned with and corresponding to each other.

In some embodiments, the engagement portion may be a protrusion portion or an engagement groove arranged in the mounting cavity.

In some embodiments, the engagement portion may be a protrusion portion arranged in the mounting cavity, wherein the protrusion portion may be arranged at an outer side with an inclined surface for the insertion of the conductive clip.

In some embodiments, the engagement portion may be arranged at an outer side with an inclined surface for the insertion of the conductive clip.

With the above technical solutions, the present invention has advantages as follows.

The connector of the present disclosure simplifies the structure of the housing, increases the yield of the housing in the manufacturing process, and improves the heat radiation performance of the connector. In particular, during the mounting, the conductive clip and the support member are placed into the mounting cavity in this order. The support member is clamped in the opening of the conductive clip, and then the plug member is inserted into the mounting cavity. When the plug member is inserted into the mounting cavity, a portion of the plug member, which fits with the engagement portion of the housing, can partially deform to pass over the engagement portion and then can be caught by the engagement portion. Due to the cooperation of the plug member with the engagement portion, the plug member can be effectively prevented from being detached from the mounting cavity. By means of the plug member inserted in the mounting cavity, the support member can be prevented from being detached from the conductive clip, and the support member and the conductive clip can be prevented from coming off from the mounting cavity. In particular, the engagement portion may be a protrusion portion or an engagement groove arranged in the mounting cavity.

The air passage arranged on the housing on one side facilitates forming the engagement portion during the manufacturing process of the housing. During the molding process of the housing, the mold for forming the engagement portion does not require any complicated structure, and the core back operation can be performed via both the mounting cavity. Thereby the air passage can facilitate the molding of the housing and greatly increase the yield of the housing in the molding process. On the other side, in the case that the conductive clip, the support member, and the plug member are mounted in the mounting cavity, the mounting cavity substantially has a closed space. By means of the air passage, the heat in the mounting cavity can be effectively discharged, and the heat generated by the current flowing through the conductive clip, the support member, and the wires during prolonged use of the connector, can be discharged.

With the above embodiments, the connector of the present disclosure simplifies the structure of the housing, increases the yield of the housing in the manufacturing process, and improves the heat radiation performance of the connector.

### BRIEF DESCRIPTION OF THE DRAWINGS

In order to describe the technical solution of embodiments of the disclosure more clearly, drawings illustrating the embodiments will be briefly described below. It should be understood that the following drawings merely show certain embodiments of the disclosure and, therefore, should not be considered to limit the scope of the disclosure. For those skilled in the art, other related drawings may also be obtained based on these drawings without any creative work.

FIG. 1 is an isometric view of a parallel-type wire connector according to an embodiment of the present disclosure;

FIG. 2 is an exploded view of a parallel-type wire connector according to an embodiment of the present disclosure;

FIG. 3 illustrates a cut view of a housing according to an embodiment of the present disclosure;

FIG. 4 is a sectional view of a parallel-type wire connector according to an embodiment of the present disclosure;

FIG. 5 illustrates a conductive clip, a support member and a wire cooperating with each other according to an embodiment of the present disclosure;

FIG. 6 shows a conductive clip and a support member according to an embodiment of the present disclosure, in an exploded manner;

FIG. 7 is an exploded view of a parallel-type wire connector according to another embodiment of the present disclosure;

### DETAILED DESCRIPTION OF ILLUSTRATED EMBODIMENTS

In order to make the purpose, technical solution and advantages of embodiments of the present disclosure more clear, the embodiments of the present disclosure will be described more completely and clearly below in conjunction with the accompanying drawings illustrating the embodiments. It is apparent that the embodiments described below are merely some, but not all, embodiments of the present disclosure. Based on the embodiments of the present disclosure, those skilled in the art may obtain other embodiments included within the scope of the present disclosure without any creative work. Therefore, the detailed description of embodiments of the present disclosure illustrated in the accompanying drawings is not intended to limit the scope of the disclosure, but rather illustrates particular embodiments of the present disclosure. Based on the embodiments of the present disclosure, those skilled in the art may obtain other embodiments included within the scope of the present disclosure without any creative work.

In the description of the present disclosure, it is to be understood that the orientational or positional relationships indicated by the terms “center”, “longitudinal”, “transversal”, “length”, “width”, “thickness”, “upper”, “lower”, “front”, “rear”, “left”, “right”, “vertical”, “horizontal”, “top”, “bottom”, “inside”, “outside”, “clockwise”, “counterclockwise”, etc. are based on the orientation or positional relationship shown in the drawings, are merely for the convenience of describing the present disclosure and simplifying the description, and do not indicate or imply that the device or component referred to must have a specific orientation or be constructed and operated in a specific orientation. Therefore, it should not be construed as limiting the present disclosure.

Moreover, the terms “first” and “second” are used for descriptive purposes only and are not to be construed as indicating or implying relative importance or implicitly indicating the number of technical features indicated. Thus, features defining “first” and “second” may include one or more of the features either explicitly or implicitly. In the description of the present disclosure, the meaning of “a plurality of” is two or more unless specifically defined otherwise.

In the present disclosure, the terms “installation,” “connected,” “attached,” fixed,” and the like shall be interpreted broadly, and, for example, maybe fixed, detachable, or integrated, unless otherwise explicitly defined. The term “connection” or “connect” could be a mechanical connection or electrical connection, and maybe directly connected or indirectly connected through an intermediate medium. For those skilled in the art, the specific meanings of the above terms in the present disclosure can be conceivable.

In the present disclosure, the first feature “on” or “under” the second feature may include direct contact or indirect contact of the first and second features, unless otherwise specifically defined. Moreover, the first feature “above,” “over,” or “onto” the second feature includes the first feature directly or indirectly above or onto the second feature. The first feature “below,” “under,” or “beneath” the second feature includes the first feature directly or indirectly below or beneath the second feature, or merely the first feature level being less than the second feature.

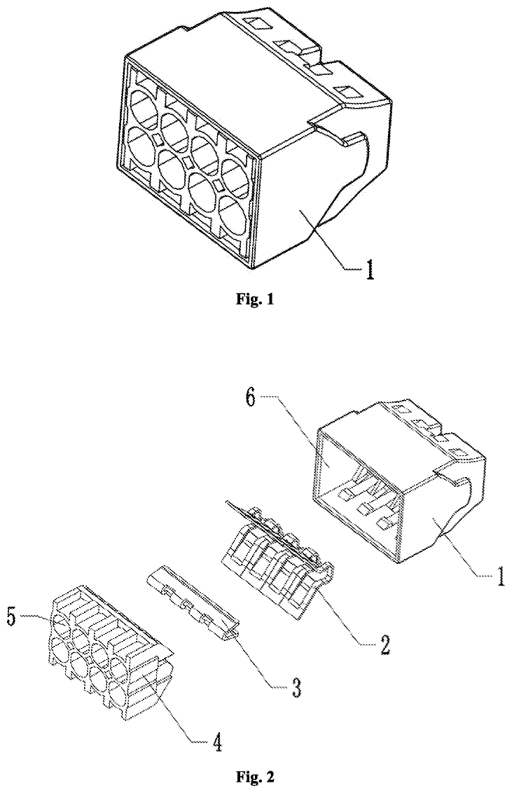

The present disclosure will be further explained below in detail with reference to figures and particular embodiments. Referring to FIGS. 1-5, a parallel-type wire connector in an embodiment comprises a housing 1 formed with a mounting cavity 6, a conductive clip 2 accommodated in the mounting cavity 6, a support member 3 disposed in the mounting cavity 6 and clamped by the conductive clip 2, and a plug member 4 provided with wire insertion holes 5 and engaged in the mounting cavity 6. The conductive clip 2 is provided with a wire passage 12 extending through the conductive clip 2 and comprises an elastic sheet 11 disposed at the wire passage 12. The mounting cavity 6 is arranged with an engagement portion 8 fitting with the plug member 4, and an air passage 7 located behind the engagement portion 8 and corresponding thereto. The air passage 7 extends through the housing 1 along a direction along which the plug member 4 is inserted into the mounting cavity 6. Wires 10 can be inserted into the wire passage 12, through the wire insertion holes 5, and sandwiched between the elastic sheet 11 and the support member 3.

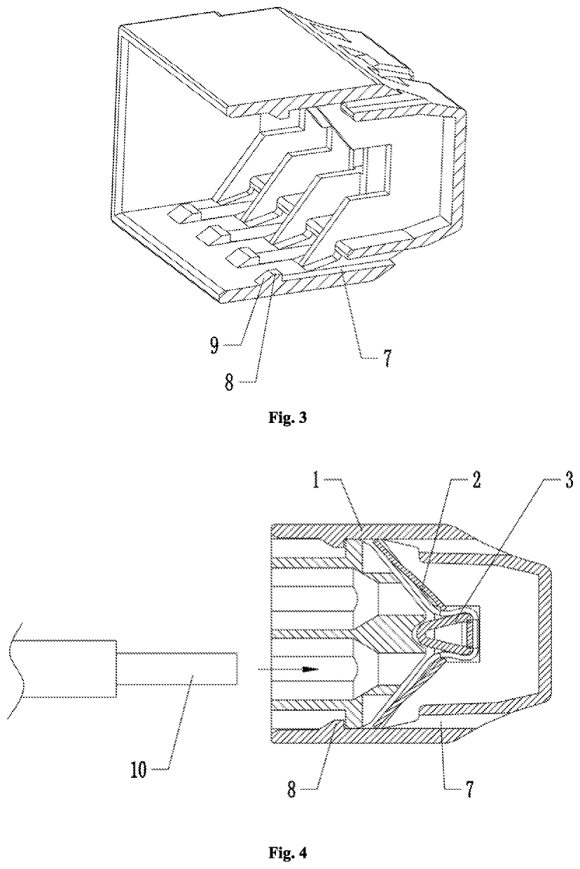

In particular, referring to FIGS. 2 and 3, when mounting the connector in the embodiment, the conductive clip 2 and the support member 3 are placed into the mounting cavity 6 in this order. The support member 3 is clamped in the opening of the conductive clip 2. Then the plug member 4 is inserted into the mounting cavity 6. When the plug member 4 is inserted into the mounting cavity 6, a portion of the plug member 4, which fits with the engagement portion 8 of the housing 1, can partially deform to pass over the engagement portion 8 and then can be caught by the engagement portion 8. Due to the cooperation of the plug member 4 with the engagement portion 8, the plug member 4 can be effectively prevented from being detached from the mounting cavity 6. By means of the plug member 4 inserted in the mounting cavity 6, the support member 3 can be prevented from being detached from the conductive clip 2. And the support member 3 and the conductive clip 2 can be prevented from coming off from the mounting cavity 6. Referring to FIGS. 2, 3 and 4, the air passage 7 arranged on the housing 1 on one side facilitates forming the engagement portion 8 during the manufacturing process of the housing 1. During the molding process of the housing 1, the mold for forming the engagement portion 8 does not require any complicated structure. The core back operation can be performed via both the mounting cavity 6 and the air passage 7. Thereby that can facilitate the molding of the housing 1, simplify the structure of the housing 1, and greatly increase the yield of the housing 1 in the molding process. On the other side, in the case that the conductive clip 2, the support member 3, and the plug member 4 are mounted in the mounting cavity 6, the mounting cavity 6 substantially has a closed space. By means of the air passage 7, the heat in the mounting cavity 6 can be effectively discharged, and the heat generated by the current flowing through the conductive clip 2, the support member 3, and the wires 10 during prolonged use of the connector, can be discharged.

Referring to FIGS. 3 and 4, the engagement portion 8 shown in the embodiment may be a protrusion portion arranged in the mounting cavity 6. The protrusion portion has an inclined surface 9 at the outer side, to facilitate the insertion of the conductive clip 2. During use, due to the engagement portion 8 having the inclined surface 9, the plug member 4 can be inserted conveniently.

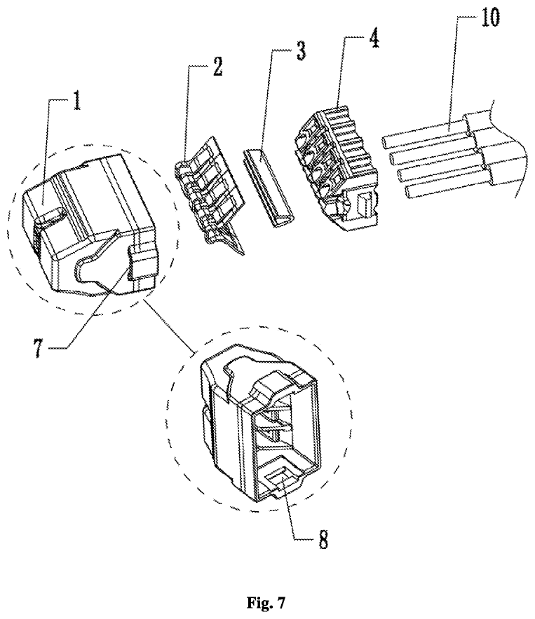

In another embodiment, referring to FIG. 7, the engagement portion 8 in the embodiment may be an engagement groove arranged in the mounting cavity 6, and the portion of the outer surface of the housing 1 which corresponds to the engagement portion 8 may have a protrusion structure, such that the air passage 7 can be arranged. In the present embodiment, the engagement portion 8 has the same function as in the previous embodiment and will not be repeated in detail herein. Furthermore, it should be noted that the engagement portion 8, either formed as the protrusion portion or the engagement groove, may be arranged on the left or right side wall or the upper or lower wall of the mounting cavity 6, and a description thereof will be omitted.

Referring to FIG. 6, the conductive clip 2 in the embodiment comprises first conductive sheets 15 disposed obliquely upward, and second conductive sheets 16 respectively connected with the first conductive sheets 15 and disposed obliquely downward, wherein the first conductive sheets 15 and the second conductive sheets 16 are disposed to form a first opening 14 therebetween, and the support member 3 can be clamped in the first opening 14. It is apparent that the support member 3 can retain the first conductive sheets 15 and the second conductive sheets 16, thereby ensuring the opening between the first conductive sheets 15 and the second conductive sheets 16 during prolonged use of the connector.

In the embodiment, the support member 3 may be a conductive geometry in a ‘V’ like shape, a second opening 17 may be formed at the opening portion of the ‘V’ like shape of the support member 3, and support pieces 13 may be arranged at the joints of the first conductive sheets 15 and the second conductive sheets 16, the support pieces 13 extending outward and disposed in the second opening 17. It is apparent that the support pieces 13 can retain the support member 3 to form the opening and prevent the opening from getting small during prolonged use of the support member 3, such that the first conductive sheets 15 and the second conductive sheets 16 can be effectively supported by the support member 3.

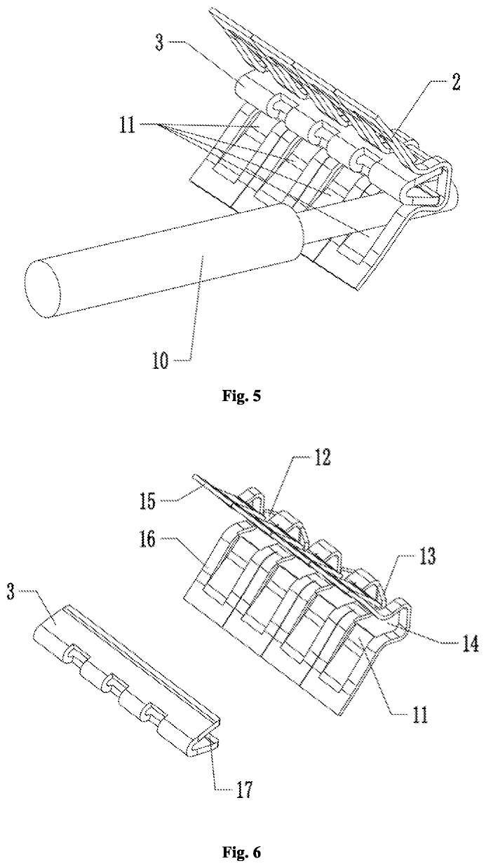

Referring to FIG. 5, the first conductive sheets 15 and the second conductive sheets 16 in the embodiment are respectively arranged with a plurality of wire passages 12 and a plurality of elastic sheets 11 aligned with and corresponding to each other. It is also conceivable that, accordingly, the plug member 4 is provided with the same number of wire insertion holes 5 as the wire passages 12.

With the above embodiments, the connector of the present disclosure simplifies the structure of the housing 1, increases the yield of the housing 1 in the manufacturing process, and improves the heat radiation performance of the connector.

All the above are merely preferred embodiments of the present disclosure and are not intended to limit the present disclosure. Those skilled in the art may change or modify the present disclosure. The present disclosure is intended to cover all changes, equivalent arrangements and modifications included within the spirit and principle of the present disclosure.

What is claimed is:

1. A parallel-type wire connector, comprising:
a housing formed with a mounting cavity;
a conductive clip accommodated in the mounting cavity;
a support member disposed in the mounting cavity and clamped by the conductive clip; and
a plug member provided with wire insertion holes and engaged in the mounting cavity;
wherein the conductive clip is arranged with wire passages extending through the conductive clip and elastic sheets disposed at the wire passages;
the mounting cavity is arranged with an engagement portion fitting with the plug member, and an air passage located behind and aligned with the engagement portion; and the air passage extends through the housing along a direction along which the plug member is inserted into the mounting cavity, and wires can be inserted through the wire insertion holes, inserted into the wire passages, and sandwiched between respective elastic sheet and the support member.

2. The parallel-type wire connector according to claim 1, wherein the conductive clip comprises first conductive sheets disposed obliquely upward, and second conductive sheets respectively connected with the first conductive sheets and disposed obliquely downward, wherein the first conductive sheets and the second conductive sheets are disposed to form a first opening therebetween, and the support member can be supported in the first opening.

3. The parallel-type wire connector according to claim 2, wherein the support member is a conductive geometry in a ‘V’ like shape, a second opening is formed at an opening portion of the ‘V’ like shape of the support member; and support pieces are arranged at joints of the first conductive sheets and the second conductive sheets, and the support pieces extending outward and inserted in the second opening.

4. The parallel-type wire connector according to claim 2, wherein the first conductive sheets and the second conductive sheets are respectively arranged with a plurality of wire passages and elastic sheets aligned with and corresponding to each other.

5. The parallel-type wire connector according to claim 1, wherein the engagement portion is a protrusion portion or an engagement groove arranged in the mounting cavity.

6. The parallel-type wire connector according to claim 5, wherein the engagement portion is the protrusion portion arranged in the mounting cavity, and the protrusion portion is arranged at an outer side with an inclined surface for insertion of the conductive clip.
